(19) United States
(12) Patent Application Publication
(10) Pub. No.: US 2006/0177197 A1
(43) Pub. Date: Aug. 10, 2006

(54) Recording and playback apparatus and method

(76) Inventors: Taku Nakamura, Yokohama (JP); Daisuke Yoshida, Yokohama (JP); Masaru Takahashi, Yokohama (JP)

Correspondence Address: MCDERMOTT WILL & EMERY LLP, 600 13TH STREET, N.W., WASHINGTON, DC, 20005-3096, US

(21) Appl. No.: 11/213,428

(22) Filed: Aug. 29, 2005

(30) Foreign Application Priority Data
Feb. 10, 2005 (JP) 2005-033770

(51) Int. Cl. H04N 5/91

(52) U.S. Cl. 386/83

(57) ABSTRACT

Disclosed herein is a recording and playback apparatus that stores plural kinds of signals, for example, programs on multiple channels. When, while one kind of signal out of the plural kinds of signals is being played back, playback of another kind of signal is instructed, the another kind of signal is played back starting from a position backward of another position which was current when the playback of the another kind of signal was instructed.

This application claims the benefit of priority of Japanese Application No. 2005-033770 filed Feb. 10, 2005, the disclosure of which also is entirely incorporated herein by reference.

### TECHNICAL FIELD

The present invention relates to a recording and playback apparatus and method for recording and playing back plural video streams.

### BACKGROUND

A recording and playback apparatus having a control function which allows, while a first program is being watched and simultaneously being recorded to a hard disk, a second program on a different channel to be temporarily watched is disclosed in Japanese Patent Laid-Open No. 2002-185899. In the apparatus, when switching is made from the channel of the first program to the channel of the second program, the current location address on the hard disk is stored. Subsequently, when switching from the second program back to the first program is made, the stored location address is read out and the first program is played back starting from a position specified by the location address that was stored when the previous channel switching was made.

Japanese Patent Laid-Open No. 9-9193 discloses another recording and playback apparatus. The apparatus is provided with plural tuners and a large-capacity video signal recording medium (such as a HDD) and records, endlessly, TV programs on plural channels making the last recorded portion lasting a prescribed length of time always available on each channel. With the apparatus, when a user wishing to watch a program starting from a past position, specifies the program and the time for the past position, the program stored in the video signal recording medium is immediately played back starting from the past position.

### SUMMARY

A TV viewer changes the channel he or she is watching not only to temporarily watch a different channel but also to, after being bored with the program he or she has been watching, look for a different program which is interesting to him or her. If, after looking for a different, interesting program, the viewer finds no program more interesting than the program he or she has been watching, the viewer continues to watch the same program. If the viewer finds a more interesting program, the viewer changes the channel he or she has been watching to watch the more interesting program. Or, the viewer may watch the two programs alternately by switching between the two channels. There may also be a case where a viewer starts watching TV broadcast or cable TV without determining in advance what to watch and then scan through plural channels to find an interesting program to watch.

In such a case, if program recording is possible on a single channel only, even if the user finds an interesting program on another channel, he or she cannot make time-shifted playback to watch the interesting program starting from a past position. This is inconvenient for the user.

Even in a case where plural channels are recorded, if the user is required to specify a position to start playback from every time he or she changes the channel selection, it is bothersome.

Under the circumstances, there has been a need for a recording and playback apparatus and method with improved usability. In view of the need, a recording and playback apparatus according to an aspect of the present invention stores plural kinds of signals, for example, programs on multiple channels. When, while one kind of signal out of the plural kinds of signals is being played back, playback of another kind of signal is instructed, the another kind of signal is played back starting from a past position backward of another position which was current when the playback of the another kind of signal was instructed.

### BRIEF DESCRIPTION OF THE DRAWINGS

The above and other objects, features, and advantages of the invention will become more apparent from the following descriptions taken in conjunction with the accompanying drawing, in which:

FIG. 1 is a schematic diagram showing an example of a recording and playback apparatus system;

FIG. 2 is a diagram showing an example external view of a remote controller;

FIG. 3 is a schematic diagram showing an example of video stream recording and playback;

FIG. 4 is a diagram showing an example flow of recording and playback operation control;

FIG. 5 is a diagram showing an example display screen of a display section 200;

FIG. 6 is a diagram showing another example display screen of the display section 200;

FIG. 7 is a diagram showing still another example display screen of the display section 200;

FIG. 8 is a diagram showing an example of a recording and playback apparatus;

FIG. 9 is a diagram showing still another example display screen of the display section 200; and

FIG. 10 is a schematic diagram showing example recording capacities of ring buffers for plural channels.

### DETAILED DESCRIPTION

An embodiment of the present invention will be described in the following with reference to the accompanying drawings.

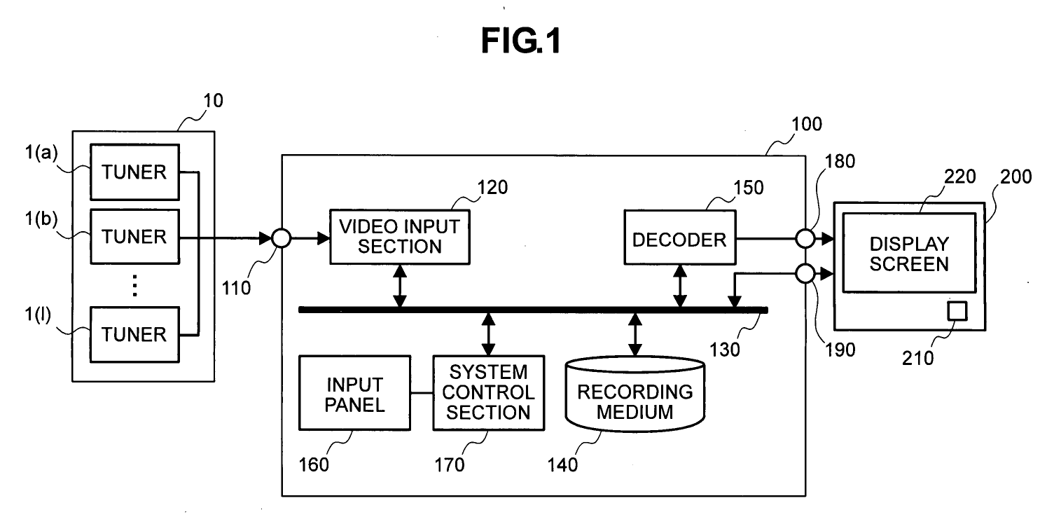

FIG. 1 is a schematic diagram showing an example of a recording and playback system including a recording and playback apparatus 100, a tuner unit 10, and a display section 200.

The tuner unit 10 includes 12 tuners 1 (a) to 1 (l) and receives video streams of 12 channels. The number of tuners need not necessarily be 12. It may be changed according to the number of channels. A video stream is a video signal compressed, for example, using MPEG-2. The following description is confined, for simplification, to video signal processing, but the present embodiment may also be applied to processing of signals inclusive of audio signals. As an example of the present embodiment, a case of watching TV broadcasts will be described below, but the present embodiment may also be applied to cable TV watching. In the case of watching cable TV, video streams are inputted to the tuner unit 10 via cables.

Plural video streams are inputted to a video input terminal 110 via the tuner unit 10. A video input section 120 receives the plural video streams from the video input terminal 110 and record them to a recording medium 140 via a bus 130. When a power button 210 of a display section 200 is turned on, or when displaying a video on a display screen 220 is instructed, a control signal is inputted from a control signal input/output terminal 190 and the recording medium 140 starts recording the video streams. How to record video streams is not limited to the above procedure. For example, regardless of whether the display section 200 is turned on or off or whether or not an instruction for displaying a video is inputted, video streams recorded, for example, for the last one hour may be made always available. Or, an arrangement may be made to receive program information such as an EPG (Electronic Program Guide), then based on the program information, record a program on each channel from its beginning, and, when the program ends and the next program starts, record the next program overwriting the previous program recorded. In this way, recording of a current program on each channel can be made always available. With an arrangement such as those described above made, a user can turn on the display section 200 to watch a TV broadcast and watch a program starting from a past position thereof. Examples of media which can be used as the recording medium 140 include, for example, such random-access media as a hard disk, a DVD-RAM, and a Blue-ray Disk.

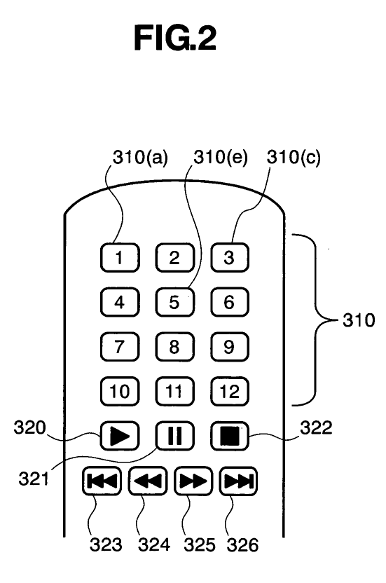

An input panel 160 includes plural operation buttons such as a channel selection button for selecting a channel the user wishes to watch, a program button for setting programmed recording, and a play button for instructing playback of a recorded program. It is used as an instruction input section for inputting user's instructions. In addition to the operation buttons, the input panel 160 also includes a radio communication terminal, for example, for making infrared communications. Therefore, the user is enabled to remote control the recording and playback apparatus 100 from a separate location using a remote controller shown in FIG. 2. The input panel 160 is not limited to one having plural operation buttons and a radio communication terminal. It may be one having either plural operation buttons or a radio communication terminal, or it may be one having a function key which can be used to perform plural functions and a reduced number of operation buttons. Adoption of such a function key allows the recording and playback apparatus to be made smaller.

A system control section 170 has, for example, a CPU (Central Processing Unit). When a channel the user wishes to watch is specified from the input panel 160, the system control section 170 receives a control signal corresponding to the channel selected by the user and performs control to cause a corresponding video stream to be read out from the recording medium 140 and outputted to a decoder 150 via the bus 130. The decoder 150 receives and decodes the video stream, and outputs the decoded video signal to the display section 200 via a video output terminal 180. As a result, the user can watch playback of the video.

In the example shown in FIG. 1, the tuner unit 10 and the display section 200 are provided outside the recording and playback apparatus 100, but the present embodiment is not limited to the configuration shown in FIG. 1. For example, the recording and playback apparatus may be a combined type having either or both of an internal tuner section and an internal display section. When the recording and playback apparatus is such a combined type, work to connect either or both of a tuner section and a display section to the recording and playback apparatus is unnecessary, so that it is easier for the user, even if he or she is not familiar with electrical appliances, to use the recording and playback apparatus. Also, when the present embodiment is to be applied to a portable terminal or the like, the terminal is preferred to be a combined type. Users of a portable terminal, in many cases, carry the portable terminal in their bag or pocket, and take it out only when using it. When their terminal is a combined type, they can use the terminal upon taking it out without being bothered to make connections to a tuner section and a display section. It is convenient for the user.

FIG. 2 is a diagram showing an example external view of a remote controller. Operation buttons 310 shown in FIG. 2 are used for channel selection. Buttons 310 (a) and 310 (c), for example, correspond to channels 1 and 3, respectively.

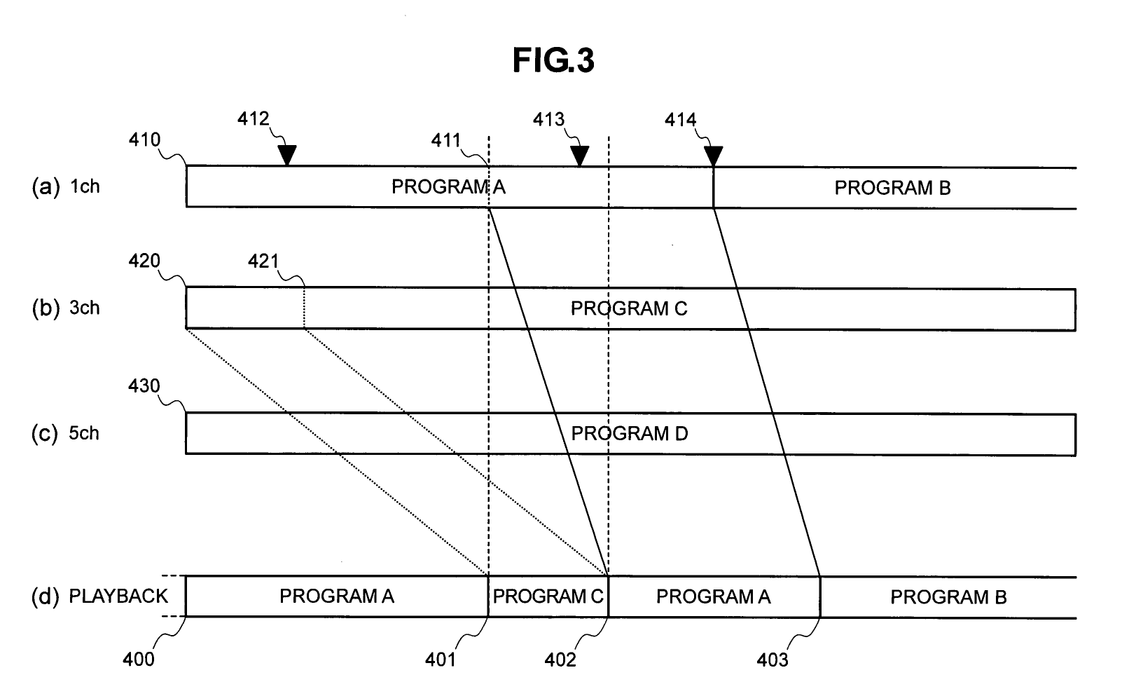

FIG. 3 is a schematic diagram showing an example of video stream recording and playback. Parts (a), (b), and (c) of FIG. 3 show that programs A and B are broadcast on channel 1, that program C is broadcast on channel 3, and that program D is broadcast on channel 5, respectively. The video streams of the respective channels are stored in the recording medium 140. Each of the video streams is recorded together with timecode such as SCR (System Clock Reference) which indicates the broadcast time. In FIG. 3, only three video streams of channels 1, 3, and 5 are shown for simplicity. In reality, the video streams of all channels outputted from the tuner unit 10 are recorded in the recording medium 140.

Part (d) of FIG. 3 shows the way in which video streams are played back from the recording medium 140. When the power button 210 of the display section 200 is turned on at time 400, each channel starts being recorded. When, to select channel 1, for example, the button 310 (a) of the remote controller is pressed, the system control section 170 reads out a video stream 410, which corresponds to the time 400, of the program A from the recording medium 140. The video stream thus read out is outputted to the display section 200 via the decoder 150 and the video output terminal 180. Next, when the user presses, at time 401, the button 310 (c) to switch from the program A to another program, the system control section 170 reads out a video stream 420 corresponding to the time 400 from the recording medium 140. As a result, the program C is played back starting from a position where it started being recorded.

If, in the above case, the video stream of the program C is played back starting from a position which is current when the channel selection is changed to switch from the program A to the another program, that is, a position forward of a position which was current when the power button 210 of the display section 200 was turned on, the viewer of the program will, in many cases, find it difficult to comprehend the program C. Also, such a position which is current when the channel selection is changed may happen to be in a section for a commercial message. In the present embodiment, a selected program is played back starting from where it started being recorded, so that it is easy for the user to grasp what the program is like. This arrangement enables the user to search for a most favorite program by switching from channel to channel.

At the same time as starting playing back the program C, the system control section 170 stops playing back the program A at a video stream 411 and records, to the recording medium 140, a timecode value corresponding to the video stream 411 as information on the position where playback of the program A was stopped. Subsequently, when channel 1 is selected again at time 402, the information on the stopped position is read out from the recording medium 140, the video stream 411 corresponding to the information is read out, and playback of the program A is started again.

As described above, when playback of a program is stopped, information on the stopped position is stored, and when the same channel is subsequently selected again, the program starts being played back from where its playback was previously stopped. In this way, the user is not required to rewind the program in order to search for the last scene he or she watched of the program. This improves convenience for the user.

At the same time as playback of the program A is started, playback of the program C is stopped at a video stream 421, and information on the stopped position is recorded to the recording medium 140. Though not shown in part (d) of FIG. 3, if, for example, channel 5 is selected after channels 1 and 3 were selected, a video stream 430, corresponding to the time 400, of a program D starts being played back. When the channel selection is subsequently changed, information on the stopped position is recorded to the recording medium 140, so that, when channel 5 is selected again, playback of the channel 5 is started from the stopped position.

With the above arrangement, it is possible for the user to successively and retroactively watch plural programs being simultaneously broadcast just by selecting a channel at a time using the buttons 310 for channel selection. This makes it easy for the user, even after the user starts watching a TV broadcast or a cable TV program without any program of interest in mind, to search for an interesting program to watch.

In the above example, the user selects arbitrary programs using the remote controller. It goes without saying that programs may be selected by pressing the buttons provided on the input panel.

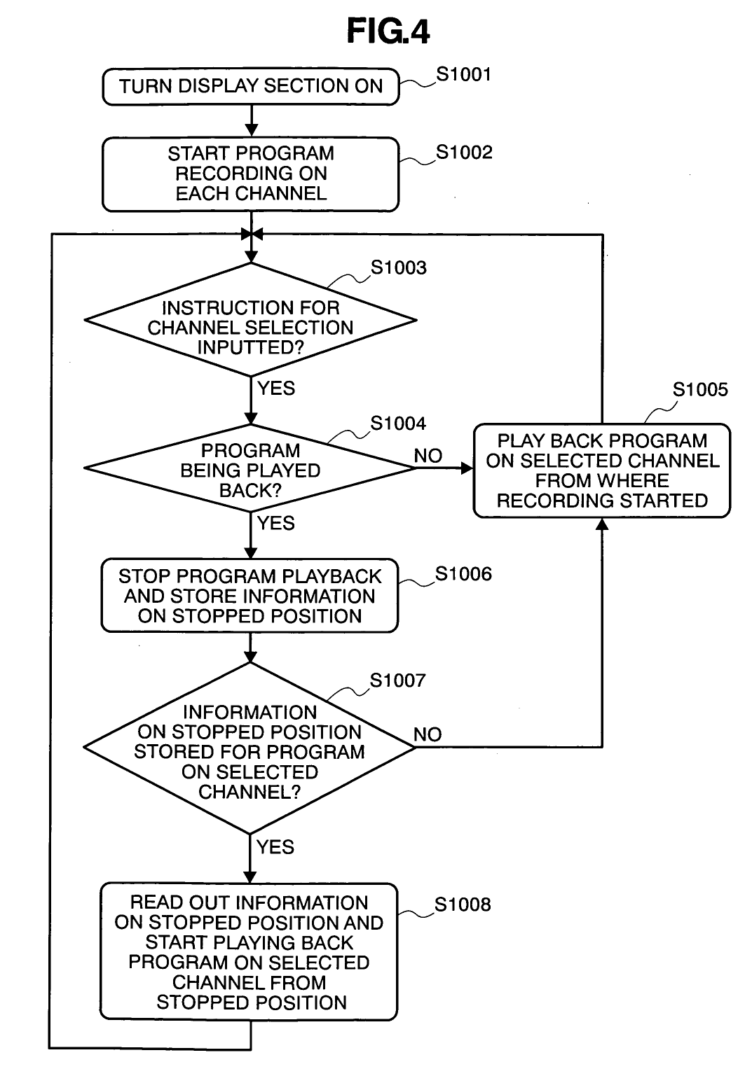

The system control section 170 controls recording and playback operations, for example, based on a control program a flowchart of which is shown in FIG. 4.

When the power button 210 of the display section 200 is turned on (step S1001), program recording on each channel starts (step S1002). When an instruction for selecting a channel is inputted via the input panel 160 (S1003), whether or not a program is being played back is determined (S1004). In a case where no program is being played back, the program on the selected channel stored in the recording medium 140 is played back retroactively from where the program started being recorded (S1005). In a case where there is a program being played back, playback of the program is stopped and information on the stopped position is stored on the recording medium 140 (S1006). Next, whether or not information on the stopped position for the selected program has been recorded on the recording medium 140 is determined (S1007). If, for the selected program, no information on the stopped position has been recorded on the recording medium 140, the program starts being played back from where it started being recorded (S1005). If, for the selected program, information on the stopped position has been recorded on the recording medium 140, the information is read out and the program starts being played back from where it previously stopped being played back.

The control program may be stored in the system control section 170, or it may be recorded on the recording medium 140 or another recording medium. The control program need not necessarily be one pre-loaded in the recording and playback apparatus 100. The user may install it after purchasing the recording and playback apparatus 100.

In the above described example, when the power button 210 of the display section 200 is turned on, recording on each channel starts. As previously stated, how to perform recording is not limited to the above way. A control flow of S1003 through S1005 can be applied to a case where programs on each channel are recorded successively from the beginning based on program information, regardless of whether the power button 210 is on or off. In such a case, control is made such that the program on the channel selected at S1005 is played back from the beginning. With such control made, every time the user changes the channel selection, he or she can watch a program on the selected channel from its beginning. This improves convenience for the user.

In the above example, when a channel, playback of which was previously stopped, is selected again, the corresponding program starts being played back from where its playback was previously stopped. A different arrangement may be made such that the program starts being played back from where a scene or content of the program changes. For example, in a case where chapter information indicating chapter locations where a scene changes is provided by a broadcast station together with video streams, the chapter information may be stored, together with the video streams, on the recording medium 140. It is then possible to make an arrangement such that, when a channel, playback of which was previously stopped, is selected again, the corresponding program starts being played back again from the chapter immediately before or immediately after where its playback was previously stopped.

Part (a) of FIG. 3 shows chapter locations 412, 413, and 414 of the program A. A case where playback of channel 1 is started, at the time 402, from the chapter location 412 or 413 depending on a selection by the user will be described in the following. When the button 310 (a) and a previous chapter button 323 of the remote controller shown in FIG. 2 are pressed in succession, the program A starts being played back retroactively from the chapter location 412 by going back beyond where its playback was previously stopped. Restarting playback of the program A from the beginning of a chapter where a scene changes enables the user to remember content of the program A even after the user forgot the content of the program A while watching the program C.

When, on the other hand, the button 310 (a) and a next chapter button 326 are pressed in succession, the program A starts being played back from the chapter location 413. The user watching a TV program often changes the channel when the program is interrupted by a commercial message or when the program enters a scene which is of no interest to the user or which the user does not like to watch. Therefore, making control such that the program starts being played back again from a position where the scene during which the user changed the channel ends, that is, from the subsequent chapter allows the user, after once stopping watching the program, to start watching the program again after the scene that the user does not like to watch ends. This improves convenience for the user.

If the user watching the program C presses the button 310 (a) and the next chapter button 326 in succession while the chapter of the program A during which its playback was previously stopped has not yet ended, a message, as shown in FIG. 5, informing of the condition and urging the user to confirm whether or not to change the channel may be displayed so as to change the channel depending on a decision by the user. If the user gives an instruction to cancel changing the channel, switching to the program A does not take place and the program C continues to be played back. On the other hand, if the user gives an instruction to change the channel, the program A is played back in real time.

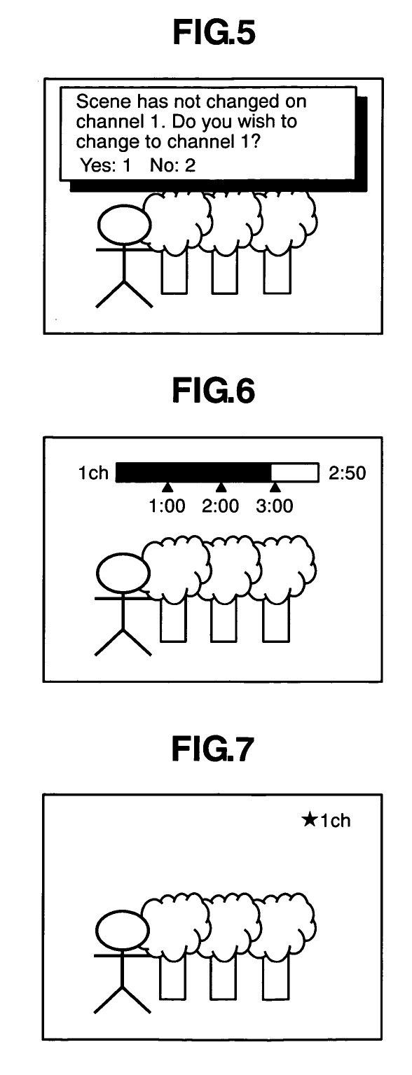

When a change from a channel to another has been made, the length of time that has elapsed since the change may be displayed in the display section 200. FIG. 6 shows an example in which the elapsed time (2 minutes and 50 seconds) since a change from channel 1 to channel 3 is displayed. Generally, commercial messages and news inserted during broadcasting of a sports game are broadcast at predetermined times. Therefore, when the time that elapsed since a channel change was made is displayed, it is easier for the user to determine an appropriate time when to change the channel. When a new chapter is entered in the program on a channel from which the user has made a change, a message informing of the chapter change may be displayed in the display section 200. In the example shown in FIG. 7, the display of a star sign and a channel number 1 indicates that a new chapter has been entered on channel 1. Such a display enables the user to notice a scene change with ease.

Even though, in the examples shown in FIGS. 6 and 7, the elapsed time since a channel change was made and chapter information are displayed, respectively, concerning one channel, such information may be displayed for more than one channel. For example, when changes are made from channel 1 to channel 2, then from channel 2 to channel 3, time information like “ch1: 2:50, ch2: 0:30” may appear on the screen displaying playback of channel 3. Or, chapter information such as “(*) 1ch, ( ) 3ch” may be displayed. With such information displayed, even in a case where a scene of a program watched by the user has turned uninteresting to the user eventually causing the user to make successive channel changes, the user can determine with ease when to return to the channel he or she was initially watching. The example displays shown in FIGS. 6 and 7 do not confine the way in which such information is to be displayed. For example, information on the elapsed time and chapter information may be combined for display on a same screen.

In the present embodiment, control is made such that playback of a program can be started from where a scene changes just by pressing one of the channel selection buttons 310 and a chapter button 323 or 326. Therefore, it is not necessary for the user to operate buttons to search for a desired position for starting playback or to input a number to specify a chapter, for example, chapter 412 or chapter 413. This improves convenience for the user.

An arrangement may be made such that playback of a program is started from a chapter preceding the immediately preceding chapter or from a chapter following the immediately following chapter according to the number of times the chapter button 323 or 326 is pressed. For example, pressing the next chapter button twice may cause playback of the program to start from the chapter position 414 that is the second chapter counted from where playback of the program was previously stopped.

Control may be arranged such that, when the button 310 is used for switching to a channel the user was previously watching, playback of the channel switched to is started from where a scene changes without requiring either of the chapter buttons 323 and 326 to be pressed. For example, in a case where, out of plural modes of playback, a mode for playback from a specific chapter is selected by the user beforehand, pressing the button 310 may start playing back a selected program from where a scene changes without requiring either of the chapter buttons 323 and 326 to be pressed.

For the present embodiment, a case where information on chapter locations is inputted to the recording and playback apparatus 100 together with video streams has been described. Application of the present embodiment, however, is not limited to such a case. In a case where information on chapter locations is not transmitted from a relevant broadcast station or the like, portions of a video stream where its signal level changes may be detected as chapter locations and such detected information on chapter locations may be used to perform control similar to the above-described. In a case where an audio signal is inputted, portions of the audio signal where its signal level changes may be detected as chapter locations. When, for example, a video signal shows a change in brightness exceeding a prescribed amount, or when the brightness increases to a white level or decreases to a black level, or when the level of an audio signal becomes very low creating an almost soundless state, corresponding portions of the signal may be detected as chapter locations. In this way, even in a case where information on chapter locations is not provided, it is possible to start playing back a program from where a scene changes. This improves convenience for the user.

It goes without saying that, after starting playback of a program automatically from where its playback was previously stopped or from where a chapter begins, the user can find a desired position using a rewind button 324 or a fast-forward button 325.

As described above, in the present embodiment, all programs being broadcast are recorded and playback is made according to a selection by the user. This makes it possible for the user to watch all of concurrently broadcast programs in their entirety.

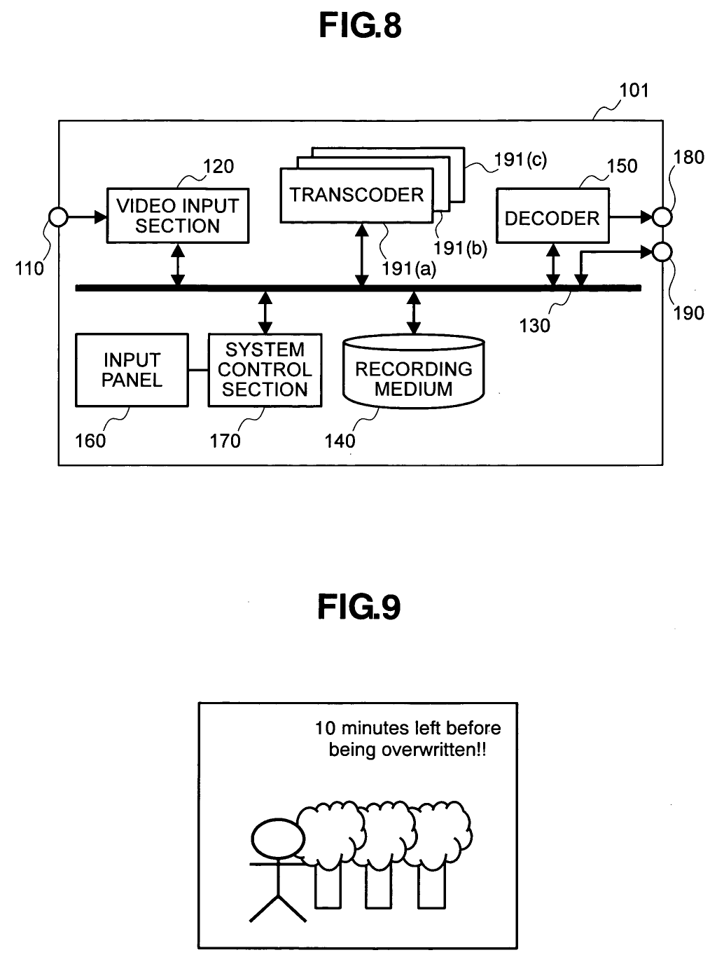

Even though, in the case of the example recording and playback apparatus shown in FIG. 1, video streams outputted from the video input section 120 are recorded to the recording medium 140 with no change made in the video stream compression ratio, the inputted video streams may be further compressed before being recorded. FIG. 8 shows an example of a recording and playback apparatus provided with transcoders 191. In FIG. 8, parts similar to those shown in FIG. 1 are denoted by the same numbers as those used in FIG. 1, and description of such parts is omitted.

The transcoders 191 receive and decode video streams from the video input section 120. The transcoders then encode the decoded video streams with a compression ratio higher than that of the initially received video streams and record the encoded video streams to the recording medium 140 at a reduced bit rate. Even though, in the example shown in FIG. 8, three transcoders are used, the number of transcoders is not limited to three. It may be smaller or larger than three. The encoding format to be used by the transcoders may be, for example, MPEG-2 the same as that of the initially received video streams or another format different from MPEG-2.

In a case where the number of programs to be received is larger than that of transcoders, the recording bit rate may be reduced for particular channels. For example, when each channel is allocated an equal capacity for recording on the recording medium 140, video streams on channels more frequently watched than others according to a history of watching may be encoded and recorded at a reduced bit rate. By doing so, such video streams on channels more frequently watched than others are given a longer recording time on the recording medium 140 than others. In a case where each channel is allowed an equal length of recording time, for example, one hour on the recording medium 140, or in a case where the recording capacity (storage capacity) is varied for different channels according to their number of times of being watched, video streams on channels less frequently watched than others may be encoded before being recorded and video streams on channels more frequently watched than others may be recorded with their bit rate unchanged. Doing so reduces the recording capacity requirement and enables the channels more frequently watched than others to be played back in good image quality. An arrangement may be made such that channels to be recorded with a reduced bit rate are selected by the user and such that video streams on the selected channels are encoded.

Next, how to store the video stream on each channel on the recording medium 140 will be described.

If the video streams on all channels inputted to the video input terminal 110 are continuously stored on the recording medium 140, the recording medium becomes full, as a result, making time-shifted recording of additionally inputted video streams impossible.

In the present embodiment, a ring buffer configuration in which the oldest video stream is deleted at fixed intervals to allow a new video stream to be recorded is used. In this way, the latest video streams can be sequentially recorded. When a video stream is to be overwritten a certain amount of time later, the time remaining before it is overwritten may be displayed as shown in FIG. 9. Displaying the time remaining before a video stream is overwritten allows the user to take an appropriate measure. For example, if the user wishes to watch a portion of a video stream soon to be overwritten, the user may switch to the corresponding channel and start watching the video stream on the channel or save a desired portion of the video stream on a separate recording medium. With such an arrangement, a problem in which video which the user is thinking of watching later is overwritten without his or her knowledge can be prevented and therefore convenience for the user can be improved. Even though, in the above example, each channel has a similar ring buffer, different channels may have different ring buffers with different capacities for recording depending on their frequency of being watched or according to user settings.

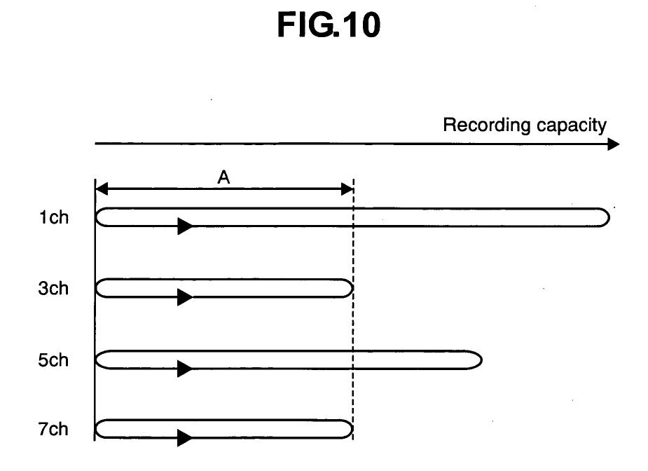

FIG. 10 is an example of a schematic diagram showing recording capacities of ring buffers for different channels. The horizontal axis of the diagram represents recording capacity. In this example, each channel is allocated a minimum recording capacity A. The recording capacity A is a capacity which allows, for example, 10 minutes of recording. The recording capacities for channels which are watched during a period of 10 minutes after recording is started are increased and the recording capacities for channels which are not watched during the period are left unchanged from the recording capacity A. FIG. 10 shows that overwriting is continued with the recording capacities for channels 1 and 5, which were watched by the user, increased according to the lengths of time they were watched and with the recording capacities for channels 3 and 7, which were not watched, left unchanged.

Though not illustrated, if any channel, for example, channel 3 is not watched at all during the 20 minutes after recording is started, the recording capacity allocated to channel 3 may be deleted. Doing so facilitates efficient use of the recording capacity of the recording medium 140. It also makes longer time-shifted playback possible for programs more frequently watched than others. Thus, convenience for the user is improved.

The recording capacity allocation for each channel may be cleared and the recording capacity A may be set anew for each channel when a certain condition is met, for example, when the recording and playback apparatus 100 is turned off, when a certain amount of time, for example, one hour elapses after the recording and playback apparatus 100 is turned off, or when a prescribed time, for example 18:00 or 19:00, arrives. The recording capacity allocation for each channel is to be subsequently varied according to the condition of being watched of each channel. Because different users watch programs in different manners, it is desirable that each user can determine when to reallocate the recording capacity for each channel.

The recording capacity for each channel may also be set at the time of starting recording based on watching history information which shows the frequency of being watched of each channel, for example, for the last one month period. It is preferable to accumulate the watching history information by, for example, day of the week or by time of day, and determine the recording capacity for each channel by time of day. Doing so makes it possible to appropriately distribute the recording capacity of the recording medium 140 to each channel even in a case where frequently watched channels vary with day of the week or with time of day.

Program information such as an EPG may be received. The received program information may then be used to effect control such that, when a program ends and a new program starts, recording of the new program automatically starts overwriting the previous program. Namely, a procedure may be used in which: a list of program starting times by channel is generated by analyzing character strings contained in the received program information; the system control section 170 refers to the list of program starting times as time goes by; and, when a time for a program to start arrives, the program that has been recorded in a ring buffer is discarded and the newly starting program is recorded from the beginning. The capacity of the ring buffer for each channel may be varied according to the broadcast times of programs known from the program information, so that even a two- or three-hour-long program can be completely recorded without being overwritten before completion.

As described above, according to the present embodiment, the user can enjoy watching programs on plural channels even when switching is to be made between the plural channels.

Even though FIGS. 5 to 7, and 9 show examples of displays on the screen, different displays may be used. For example, plural messages may be displayed on a screen to allow the user to make his or her selection. Depending on the user, text messages may be preferred or display of simple marks or symbols which are not obtrusive on the screen may be preferred. When selectable screen displays are prepared, the user can select one suitable for his or her way of use.

An arrangement as follows is preferable: two modes, “ordinary watching mode” and “time-shifted watching mode”, are prepared; in the time-shifted watching mode, control as described above for the present embodiment is effected; and, in the ordinary watching mode, no recording is made and the current program on the currently selected channel is displayed in the display section, that is, when a different channel is selected, the program being broadcast on the different channel is displayed. Such modes may be set in a same manner regardless of time of day or day of the week, or they may be arbitrarily set by the user according to time of day or day of the week. There are cases where the user does not want to make time-shifted playback. Making control variable according to the way of use of the user can improve convenience for the user.

According to the embodiment described above, a recording and playback apparatus and method with improved usability can be provided.

The foregoing invention has been described in terms of preferred embodiments. However, those skilled, in the art will recognize that many variations of such embodiments exist. Such variations are intended to be within the scope of the present invention and the appended claims.

What is claimed is:

1. A recording and playback apparatus comprising:
a signal input section to which a plurality of kinds of signals including a first signal and a second signal are inputted;
a memory which stores the plurality of kinds of signals inputted from the signal input section;
an instruction input section to which an instruction for selecting, from the plurality of kinks of signals, a signal to be watched by a user is inputted; and
a controller which controls such that, when an instruction for selecting the second signal is inputted to the instruction input section after the first signal, an instruction for selecting which has been inputted, is read out from the memory, the second signal is read out, starting from a position backward of another position that was current when the instruction for selecting the second signal was inputted, from the memory.

2. The recording and playback apparatus according to claim 1, wherein the controller, whereas controlling such that the second signal is played back starting from the position backward of the another position that was current when the instruction for selecting the second signal was inputted, also controls such that:
information on stopped position indicating where reading of the first signal was stopped is stored in the memory, and,
when the instruction for selecting the first signal was inputted again, the first signal is read out using the information on stopped position.

3. The recording and playback apparatus according to claim 1, wherein the position backward of the another position that was current when the instruction for selecting the second signal was inputted is a position from which recording of the second signal to the memory was started.

4. The recording and playback apparatus according to claim 1, wherein:
the plurality of kinds of signals are program data on a plurality of channels,
the second signal is a video signal of a program on a second channel, and
the controller controls such that, when the instruction for selecting the second signal is inputted to the instruction input section, the video signal of the program is read out from a beginning thereof, the beginning being backward of the another position that was current when the instruction for selecting the second signal was inputted.

5. The recording and playback apparatus according to claim 1, wherein the plurality of kinds of signals are signals on a plurality of channels.

6. The recording and playback apparatus according to claim 5, further comprising:
a tuner which receives the signals on the plurality of channels;
wherein the signals are inputted from the tuner to the instruction input section.

7. The recording and playback apparatus according to claim 1, wherein
the controller controls, using the information on stopped position, such that the first signal is read out starting from the stopped position.

8. The recording and playback apparatus according to claim 2, wherein control is made such that:
together with the plurality of kinds of signals, change information indicating where changes occur in the signals is inputted to the input section and,
using the information on stopped position and the change information, the first signal is read out starting from a position at which a change occurs and which is immediately before or after the stopped position.

9. The recording and playback apparatus according to claim 2, wherein the controller detects where changes occur in the signals and controls such that the first signal is read out starting from a position at which a change occurs and which is immediately before or after the stopped position.

10. The recording and playback apparatus according to claim 2, further comprising:
a display which displays a signal read out from the memory;
wherein the controller controls such that information showing an elapsed time since reading of the first signal was stopped is outputted to the display.

11. The recording and playback apparatus according to claim 8, further comprising:
a display which displays a signal read out from the memory;
wherein the controller controls such that information indicating whether or not a change occurred in the first signal after reading of the first signal was stopped is outputted to the display.

12. The recording and playback apparatus according to claim 1, further comprising:
a compressor which compresses signals;
wherein the memory has an equal recording capacity for each of the plurality of kinds of signals and frequently watched kinds of signals selected by the instruction input section are inputted to the compressor.

13. The recording and playback apparatus according to claim 1, further comprising:
a compressor which compresses signals;
wherein the memory varies a recording capacity for each of the plurality of kinds of signals according to a frequency of being selected by the instruction input section, and
wherein kinds of signals infrequently selected by the instruction input section are inputted to the compressor.

14. A recording and playback method, comprising:
acquiring signals on a plurality of channels including a first channel and a second channel,
storing the signals on the plurality of channels thus acquired,
when, while the first channel is being played back, the second channel is selected as a channel to be watched by a user, playing back the second channel starting from a position where recording of the signal on the second channel started and storing information indicating a position where playback of the first channel was stopped, and,
when the first channel is selected again as the channel to be watched by the user, playing back the signal on the first channel using the information on stopped position.

15. The recording and playback method according to claim 14, wherein the signal on the first channel is played back, using the information on stopped position, starting from the stopped position.

16. The recording and playback method according to claim 14, wherein:
change information indicating where changes occur in the signals is acquired and the signal on the first channel is played back starting from a position at which a change occurs and which is immediately before or after the stopped position.

17. A recording and playback apparatus comprising:
an input section to which a video signal is inputted;
a memory which stores the video signal inputted from the input section;
an instruction input section to which an instruction for playing back the video signal stored in the memory or an instruction for stopping playback is inputted, and
a controller which controls such that, when, after playback of a video signal is stopped according to the instruction for stopping playback given by the instruction input section, the instruction for playing back the video signal is inputted to the instruction input section, playback of the video signal is started from a position at which a change occurs in the video signal and which is immediately before or after where playback of the video signal was stopped.
